(19) United States
(12) Patent Application Publication
(10) Pub. No.: US 2017/0149556 A1
(43) Pub. Date: May 25, 2017

(54) OPERATING METHOD FOR AN ELECTRONIC DEVICE AND ELECTRONIC DEVICE

(71) Applicant: Robert Bosch GmbH, Stuttgart (DE)

(72) Inventors: Herve Seudie, Moensheim (DE); Paulius Duplys, Markgroeningen (DE)

(21) Appl. No.: 15/347,597

(22) Filed: Nov. 9, 2016

(30) Foreign Application Priority Data
Nov. 20, 2015 (DE) 102015222968.8

(51) Int. Cl. H04L 9/00; H04L 9/06; G06F 9/30

(52) U.S. Cl. CPC H04L 9/004; G06F 9/30036; H04L 9/06

(57) ABSTRACT

A method for operating an electronic device which includes at least one functional unit, the operation of which is characterized by one or multiple state variables, the method including forming a predefinable number of state vectors at different predefinable points in time, each state vector containing one or multiple state variables of the functional unit and/or of the device; ascertaining, as a function of at least one of the predefinable number of state vectors, whether a regular operation of the device and/or its functional unit exists.

### CROSS REFERENCE

The present application claims the benefit under 35 U.S.C. §119 of German Patent Application No. DE 102015222968.8 filed on Nov. 20, 2015, which is expressly incorporated herein by reference in its entirety.

### BACKGROUND INFORMATION

The present invention relates to a method for operating an electronic device, which includes at least one functional unit, the operation of which has one or multiple state variables. The electronic device may be, for example, a data processing unit, which processes data with, among other things, the aid of its functional unit.

The present invention also relates to an electronic device having at least one functional unit, the operation of which has one or multiple state variables.

Conventional electronic devices or data processing devices or data processing methods are used for, among other things, carrying out cryptographic methods or for processing security-related data in general, in particular, also in the area of IT security. Conventionally, the aforementioned systems and methods or, more precisely, their specific implementation on the hardware and software side in a target system such as, for example, a microcontroller or the like are attackable with the aid of so-called side channel attacks. In these side channel attacks, one or multiple physical parameters (for example, power consumption, electromagnetic radiation, etc.) of a system to be attacked are detected and examined with respect to a correlation with secret data such as, for example, secret keys of cryptographic methods. From this, an attacker may obtain information about the secret key and/or the processed data.

### SUMMARY

It is an object of the present invention to provide an improved method and device of the aforementioned kind to the extent that security against side channel attacks is increased.

This object is achieved according to an example embodiment of the present invention in a method of the aforementioned kind in that the method includes the following steps: forming a predefinable number of state vectors at different predefinable points in time, each state vector including one or multiple state variables of the functional unit and/or of the device; ascertaining as a function of at least one of the predefinable number of state vectors whether a regular operation of the device and/or its functional unit exists.

According to the present invention, a regular operation of the device or an operation deviating from the regular operation of the device may be deduced based on one state vector or multiple state vectors, which characterize the operation of the functional unit or the electronic device containing the functional unit. Thus, the existence of an irregular operation may be ascertained, as it may occur, for example, in conjunction with a side channel attack, based so to speak on the operating behavior, characterized by the observed state vector or state vectors. The present invention may therefore also be considered a “behavioral-based” approach for detecting and, if necessary, also for defending against side channel attacks.

In one preferred specific embodiment, it is provided that the step of ascertaining includes the following step: comparing an individual state vector with at least one predefinable reference state vector. It is possible, for example, that in some specific embodiments, particular values of an observed state vector occur with only a relatively low degree of probability in conjunction with a regular operation. In this case, an attack such as, for example, a side channel attack, may already be deduced and/or an operation of the device, in particular, also the formation of the state vectors, may be adapted to the present situation (for example, formation of multiple state vectors in a tighter time sequence than prior to the evaluation of the one state vector).

In another advantageous specific embodiment, it is provided that the step of forming includes the formation of more than one state vector at correspondingly different predefinable points in time, a state sequence being obtained, which advantageously enables a more precise ascertainment of a potentially irregular state of the device, since in the present case a sequence of state vectors and the states contained therein, thus also information about corresponding state transitions, are obtained when taking the value of a state vector into account, as compared to the previously described specific embodiment.

In another advantageous specific embodiment, it is provided that the step of ascertaining includes the following step: comparing the state sequence with at least one predefinable reference state sequence. In this way, it is possible to particularly precisely deduce the existence of a regular or irregular operating state.

In another advantageous specific embodiment, it is provided that a regular operation of the device is deduced if the comparison of the individual state vector with the at least one predefinable reference state vector indicates that the individual state vector deviates from the reference state vector by no more than a predefinable measure, a regular operation of the device being deduced, in particular, when the comparison of the individual state vector with the at least one predefinable reference state vector indicates that the individual state vector is identical to the reference state vector.

In another advantageous specific embodiment, it is provided that a regular operation of the device is deduced if the comparison of the state sequence with the at least one predefinable reference state sequence indicates that the state sequence deviates from the reference state sequence by no more than a predefinable measure, a regular operation of the device being deduced, in particular, when the comparison of the state sequence with the at least one predefinable reference state sequence indicates that the individual state sequence is identical to the reference state sequence.

In another advantageous specific embodiment, it is provided that when it is deduced in the step of ascertaining that no regular operation of the device and/or its functional unit exists, countermeasures are then initiated in a subsequent step, which include at least one of the following steps:
a. Signaling of an irregular operation to a user of the device and/or to a unit situated externally to the device,
b. Recording one or multiple state variables of the functional unit and/or of the device,
c. Modifying and/or deleting data stored in the functional unit and/or in the device, in particular, deleting stored secret data and/or falsifying stored secret data,
d. Controlling and/or influencing an operation of the functional unit, in particular, releasing and/or blocking functions of the functional unit.

An example device according to the present invention is provided for further achieving the object of the present invention. Advantageous embodiments are described herein.

An example control unit according to the present invention is provided for achieving the object of the present invention. The control unit for an electronic device having at least one functional unit, the operation of which has one or multiple state variables, is designed to carry out the following steps: forming a predefinable number of state vectors at different predefinable points in time, each state vector including one or multiple state variables of the functional unit and/or of the device; ascertaining as a function of at least one of the predefinable number of state vectors whether a regular operation of the device and/or its functional unit exists. One example control unit according to the present invention is designed, analogously to the example device according to the present invention, to carry out the example method according to the present invention.

Exemplary specific embodiments of the present invention are explained below with reference to the figures.

### BRIEF DESCRIPTION OF THE DRAWINGS

FIG. 1 schematically shows a device according to one specific embodiment.

FIG. 2 schematically shows a simplified flow chart of one specific embodiment of the method according to the present invention.

FIG. 3 schematically shows a time diagram according to another specific embodiment.

FIG. 4 schematically shows another specific embodiment.

### DETAILED DESCRIPTION OF EXAMPLE EMBODIMENTS

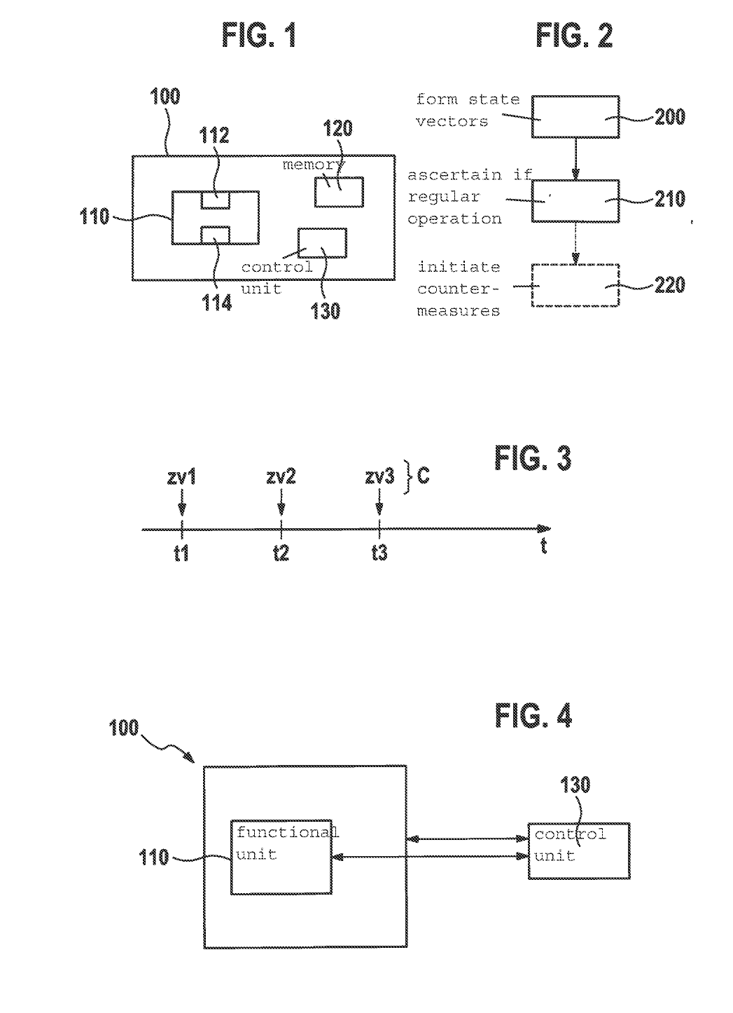

FIG. 1 schematically shows an electronic device 100 according to one specific embodiment. Electronic device 100 may, for example, be a processing unit such as, for example, a microcontroller or a processor or the like, or a data processing unit in general. Device 100 may, for example, also be at least partly implemented in the form of a programmable logic module (FPGA, field programmable gate array) or ASIC (application specific integrated circuit).

Device 100 includes at least one functional unit 110, which is designed to carry out one or multiple functions, in particular, data processing functions. Data processing functions include, in particular, but not exclusively, computing functions, logic functions. In a particularly preferred specific embodiment, functional unit 110 is designed for carrying out a cryptographic method or a part thereof.

In the present case, the functional unit 110 is designed, for example, to carry out a block encryption of data according to AES (advanced encryption standard). Information on the advance encryption standard is available on the Internet at “http://csrc.nist.gov/publications/fips/fips197/fips-197.pdf,” Federal Information Processing Standards Publication 197, Nov. 26, 2001. For this purpose, functional unit 110 includes an input 112, at which it may receive input data to be encrypted, either from a unit not shown situated externally to device 100 and/or from an additional unit also not shown situated internally in device 100. Functional unit 110 may output the AES encrypted input data at an output 114.

The operation of functional unit 110 is characterized by one or multiple state variables. In the present case, a state of functional unit 110 may be described, for example, by the set S_t=[s_0, s_1, . . . , s_n]_t of all n many state variables s_0, s_1, . . . , s_n of functional unit 110 at point in time t. The state variables s_0, s_1, . . . , s_n of functional unit 110 may, for example, be values of memory registers or memory cells of the functional unit.

A state of device 100 or of additional components of device 100 (in addition to functional unit 110) may analogously be described by additional corresponding state variables of the device or of additional components thereof.

According to the present invention, the method described below with reference to the flow chart of FIG. 2 is carried out, in particular, in order to obtain information about an operation of device 100 or of its functional unit 110.

In a first step 200, a predefinable number of state vectors zv1, zv2, zv3 is formed at different predefinable points in time t1, t2, t3, each state vector zv1, zv2, zv3 containing one or multiple state variables of functional unit 110 and/or of device 100. This is schematically indicated in the time diagram of FIG. 3, in which it is apparent that, for example, state vectors zv1, zv2, zv3 are each periodically formed, in the present case, for example, at three points in time t1, t2, t3. The majority of ascertained state vectors zv1, zv2, zv3 forms a state sequence C.

In one preferred specific embodiment, each state vector zv1, zv2, zv3 contains the same state variable(s). It may be provided, for example, that each state variable zv1, zv2, zv3 contains all state variables of functional unit 110. In this case, therefore, each state vector zv1, zv2, zv3 contains the entire set S_t=[s_0, s_1, . . . , s_n]_t.

It may also be particularly preferably provided in the case of other specific embodiments, that each state vector zv1, zv2, zv3 contains only a subset of the entire set S_t, the subset including the state variables of functional unit 110, for example, which have particular significance within the meaning of the evaluation according to the present invention with respect to a regular or irregular state of functional unit 110.

Alternatively or in addition, each state vector zv1, zv2, zv3 may also include one or multiple state variables of device 100 or of additional components thereof (not shown).

In general, it is also possible that not all considered state vectors zv1, zv2, zv3 include the same set or subset of state variables.

In a second step 210 of the method according to FIG. 2, it is ascertained as a function of at least one of the predefinable number of state vectors zv1, zv2, zv3 whether a regular operation of device 100 and/or its functional unit 110 exists.

In one specific embodiment, this may take place in that step 210 includes the following step: comparing an individual state vector zv1 with at least one predefinable reference state vector. If a state sequence C has been obtained in step 200, i.e., more than one state vector zv1, step 210 in another specific embodiment may advantageously also include the following step: comparing state sequence C with at least one predefinable reference state sequence.

The reference state vector or the reference state sequence may, for example, be ascertained by functional unit 110 (FIG. 1) in a test operation of device 100 under defined conditions such as, for example, input data, surroundings conditions, number of implementations of certain functions, etc., and be stored—if necessary, also in compressed form—for example in a memory unit 120 of device 100 for later implementation of the method according to FIG. 2.

In one preferred specific embodiment, a regular operation of device 100 (FIG. 1) is deduced if the comparison of the individual state vector with the at least one predefinable reference state vector carried out in step 210 indicates that the individual state vector deviates from the reference state vector by no more than a predefinable measure, a regular operation of device 100 being deduced, in particular, when the comparison of the individual state vector with the at least one predefinable reference state vector indicates that the individual state vector is identical to the reference state vector. In this case, the individual state vector considered according to the present invention therefore corresponds essentially or even identically to the reference state vector characterizing a known reference state, so that an irregular operation of the device, for example, a side channel attack, cannot be assumed.

In another preferred specific embodiment, a regular operation of device 100 is deduced if the comparison of the state sequence C (FIG. 3) with the at least one predefinable reference state sequence in step 210 (FIG. 2) indicates that the state sequence C deviates from the reference state sequence by no more than a predefinable measure, a regular operation of device 100 being deduced, in particular, if the comparison of the state sequence C with the at least one predefinable reference state sequence indicates that the state sequence C is identical to the reference state sequence.

Otherwise, if, for example, state sequence C is not identical to the reference state sequence or if the state sequence C deviates from the reference state sequence beyond a predefinable measure, an irregular operation of device 100 or of its functional unit 110 may be deduced. This is the case, for example, if in conjunction with a side channel attack, a certain, for example, cryptographic, function of functional unit 110 is carried out with a high number of repetitions in succession, whereas in a normal application of the AES algorithm by functional unit 110 to the input data fed to it, the same function would be carried out relatively seldom. Such differences in the behavior of device 100 are advantageously detectable with the approach according to the present invention.

In another specific embodiment, it is provided that if it is deduced in the step of ascertaining 201 (FIG. 2) that no regular operation of device 100 (FIG. 1) and/or of its functional unit 110 exists, countermeasures are then initiated in an optional subsequent step 220 (FIG. 2), which include at least one of the following steps:
a. Signaling an irregular operation to a user of device 100 and/or to a unit situated externally to device 100,
b. Recording one or multiple state variables of functional unit 110 and/or of device 100 (for example, having a higher time density than since then, cf. FIG. 3, to enable, if necessary a validation of the operation of device 100 or to be able to check the evaluation from step 210),
c. Modifying and/or deleting data stored in functional unit 110 and/or device 100, in particular, deleting stored secret data and/or falsifying stored secret data (for example, deleting or modifying a secret cryptographic key, in order to thwart, by falsified values, subsequent side channel attacks),
d. Controlling and/or influencing an operation of functional unit 110, in particular, unblocking and/or blocking functions of functional unit 110 (for example, by deactivating an electrical power supply of functional unit 110).

In another specific embodiment, it is provided that the method according to the present invention is carried out by functional unit 110, for example, prior to implementation of a cryptographic function, in order to detect in a timely manner a potentially irregular operation of device 100 or of functional unit 110 prior to the processing of sensitive data.

In another specific embodiment, it is provided that the method according to the present invention is carried out only if functional unit 110 is being operated. In this case, the behavior-based monitoring according to the present invention is active only if functional unit 110 is also active or its activation is imminent, so that the behavior-based monitoring according to the present invention is not active with respect to other functional components of the device.

In another specific embodiment, it is provided that device 100 includes a control unit 130 (FIG. 1) for carrying out the method according to the present invention, in particular steps 200, 210 200 from FIG. 2. The functionality of control unit 130 may, for example, be implemented in the same processing unit (and/or FPGA, ASIC), which also provides the functionality of functional unit 110.

Control unit 130 may, for example, be designed to access the state variables of functional unit 110, and/or to initiate one or multiple of the aforementioned countermeasures.

FIG. 4 schematically shows another specific embodiment of the present invention. In contrast to FIG. 1, control unit 130, which is designed for carrying out the method according to the present invention, is designed as an external unit with respect to device 100 and/or to functional unit 110. For example, device 100 includes a first processing unit, which provides the functionality of functional unit 110, and control unit 130 is provided in the form of a second processing unit separate from the first processing unit. Control unit 130 is able to access the state variables of functional unit 110 and/or of device 100, which in the present case is indicated by the double arrows not marked (this is implementable, for example, by a dual port RAM, to which both processing units have access and/or by a “reflecting” of the data of interest from device 100 into a shared memory usable by units 100, 130). Control unit 130 may, if necessary, also act on functional unit 110 and/or device 100 in terms of the optional countermeasures (step 220 from FIG. 2) described above.

The functionality of device 100 according to the present invention may be particularly advantageously employed in control devices, for example, for internal combustion engines of motor vehicles and/or power tools or household appliances.

One example of use of the present invention relates to the use of device 100 or control unit 130 in a control device of a motor vehicle. For example, the control device (not shown) may receive messages from another control device, which are provided with a message authentication code (MAC), in order to be able to check the integrity of the messages. The control device may then verify the received messages or their MAC, the AES block cipher or another function of functional unit 110 being used, for example. If this verification of the MAC takes place during a regular operation of the control device, it is related to certain state transitions of the control device or of functional unit 110. It is conceivable, for example, that the control device receives and verifies messages and MACs during a regular operation only with a time interval that exceeds a predefinable threshold value (and not continuously, for example, i.e. in essentially shorter time intervals, for example). Alternatively or in addition, it may be specified that the control device receives and/or verifies messages and MACs only after the occurrence of certain interrupt prompts (corresponding to certain events, for example, receipt of a message via a bus system) of a processing unit assigned to it. Alternatively or in addition, it may be specified that the control device receives and/or verifies messages and MACs only after the start of an internal combustion engine of the motor vehicle. All of these scenarios are characterizable by predefinable reference state vectors or reference state sequences, ascertainable, for example, in a test system, so that deviations therefrom are detectable by the concept according to the present invention as a function of actually ascertained states or state transitions.

The present invention advantageously enables, in particular, behavior-based deviations from regular states in electronic devices 100 such as, for example, processing units of control devices, cryptographic functional units, etc., to be detected and, if necessary, countermeasures to be initiated. In this way, it is possible to thwart conventional side channel attacks (for example, by deleting the secret data or deactivating functional unit 110), in which operating states (for example, frequently repeated implementation of the AES block cipher with the same or slightly changing input data) normally classifiable in terms of the present invention as irregular operating states occur.

In order, nevertheless, to be able to further carry out additional side channel attacks (SCA) when applying the present invention, the attacker must ensure that each of these attacks takes place in connection with a regular operating state, and thus, are not identifiable as an irregular operation by the concept according to the present invention. This significantly inhibits the collection of, for example, measurement data to be correlated with one another frequently necessary for successful SCAs, because the rate with which these data are obtainable by the attacker is very low, due to the specifically required output states for a repeated SCA as compared to conventional systems. As a result, many SCAs become inefficient.

The functionality according to the present invention may be advantageously efficiently implemented both in hardware (for example, dedicated ASIC as control unit 130) and also in software (for example, program code for a processing unit of device 100, which carries out the method according to the present invention) or in a combination thereof. In addition, an implementation of the present invention may be easily tested, in contrast to SCA defensive measures such as maskings that are implementable at the silicon or chip level. Moreover, the effectiveness of the present invention, or the increased effort required according to the present invention for SCAs, is relatively easily ascertainable if the state space of target system 100 or 110 is known.

What is claimed is:

1. A method for operating an electronic device which includes at least one functional unit, operation of which is characterized by one or multiple state variables, the method comprising:
forming a predefinable number of state vectors at different predefinable points in time, each state vector containing one or multiple state variables of at least one of the functional unit and the device; and
ascertaining as a function of at least one of the predefinable number of state vectors whether a regular operation of at least one of the device and its functional unit exists.

2. The method as recited in claim 1, wherein the ascertaining step includes comparing an individual state vector with at least one predefinable reference state vector.

3. The method as recited in claim 3, wherein the forming step includes formation of more than one state vector at correspondingly different predefinable points in time, a state sequence being obtained.

4. The method as recited in claim 3, wherein the ascertaining step includes comparing the state sequence with at least one predefinable reference state sequence.

5. The method as recited in claim 4, wherein a regular operation of the device is deduced if the comparison of the individual state vector with the at least one predefinable reference state vector indicates that the individual state vector deviates from the reference state vector by no more than a predefinable measure, a regular operation of the device being deduced if the comparison of the individual state vector with the at least one predefinable reference state vector indicates that the individual state vector is identical to the reference state vector.

6. The method as recited in claim 5, wherein a regular operation of the device is deduced if the comparison of the state sequence with the at least one predefinable reference state sequence indicates that the state sequence deviates from the reference state sequence by no more than a predefinable measure, a regular operation of the device being deduced if the comparison of the state sequence with the at least one predefinable reference state sequence indicates that the state sequence is identical to the reference state sequence.

7. The method as recited in claim 1, wherein, if it is deduced in the step of ascertaining that no regular operation of the at least one of the device and the functional unit exists, countermeasures are initiated in a subsequent step, which include at least one of the following steps:
a. signaling an irregular operation to a user of the at least one of the device and a unit situated externally of the device;
b. recording one or multiple state variables of the at least one of the functional unit and the device;
c. at least one of modifying and deleting data stored in the at least one of the functional unit and the device including at least one of deleting stored secret data and falsifying stored secret data; and
d. at least one of controlling and influencing an operation of the functional unit by at least one of unblocking and blocking functions of the functional unit.

8. An electronic device, including at least one functional unit, operation of which is characterized by one or multiple state variables, wherein the device is designed to:
form a predefinable number of state vectors at different predefinable points in time, each state vector containing one or multiple state variables of at least one of the functional unit and the device; and
ascertain, as a function of at least one of the predefinable number of state vectors, whether a regular operation of at least one of the device and its functional unit exists.

9. The device as recited in claim 8, wherein during the ascertaining, the device is designed to compare an individual state vector with at least one predefinable reference state vector.

10. The device as recited in claim 8, wherein the device includes a processing unit, and the state variable or state variables characterizes or characterize one or multiple memory cells of the processing unit.

11. The device as recited in claim 10, wherein the functional unit is designed to carry out a cryptographic method or a part thereof.

12. The device as recited in claim 8, wherein the device is designed to perform at least one of the forming and ascertaining when the functional unit is being operated, and being designed not to carry out the at least one of the forming and the ascertaining when the functional unit is not being operated.

13. A control unit for an electronic device including at least one functional unit, operation of which is characterized by one or multiple state variables, wherein the control unit is designed to:
form a predefinable number of state vectors at different predefinable points in time, each state vector containing one or multiple state variables of at least one of the functional unit and the device; and
ascertain, as a function of at least one of the predefinable number of state vectors, whether a regular operation of at least one of the device and its functional unit exists.
